(19) United States
(12) Patent Application Publication
(10) Pub. No.: US 2023/0364569 A1
(43) Pub. Date: Nov. 16, 2023

(54) VOLUMETRIC MIXER

(71) Applicant: VOL-TAR LIMITED, West Yorkshire (GB)

(72) Inventor: Samuel Joseph Stringer HUNTER, West Yorkshire (GB)

(21) Appl. No.: 18/029,584

(22) PCT Filed: Oct. 22, 2021
(86) PCT No.: PCT/GB2021/052750

§ 371 Date: Mar. 30, 2023

(30) Foreign Application Priority Data
Oct. 2, 2020 (GB) 2015671.7

(51) Int. Cl. B01F 35/88; B01F 35/93; B01F 33/502; B01F 35/221; B01F 35/21; B28C 5/42; B28C 5/46

(52) U.S. Cl. CPC B01F 35/881; B01F 35/93; B01F 33/5021; B01F 35/2211; B01F 35/2217; B01F 35/2117; B28C 5/4289; B28C 5/466; B28C 5/422; B01F 2101/28

(57) ABSTRACT

A volumetric mixer is provided including a holding section adapted to store one or more materials simultaneously, one or more conveyors disposed in the holding section, a mixing section, one or more heating units disposed in the mixing section, and a control unit. The conveyors are operable to convey materials from the holding section to the mixing section and the one or more conveyors are operable to be individually controlled by the control unit to deliver a pre-determined amount of each material from the holding section to the mixing section.

### FIELD

The present invention is related to an apparatus and method of mixing using a volumetric mixer

### BACKGROUND

Traditional mixers for substances such as concrete, asphalt and tarmac are designed to be loaded with the substance pre-mixed, for delivery to the desired area. These mixers are often known as ‘dumper’ mixers, wherein the mixed product is rotated constantly to stop it setting while in transit. Pre-mixing the materials can often lead to wasted product, and therefore excess cost for the user or client.

Furthermore, these traditional mixers are designed to be manually operated on site. This operation includes a user moving burners into a heating position. These burners are typically external or standalone burners, and may be exposed. This puts the user at risk of being burnt, as well as having to work in close proximity to large mixing blades.

The present invention overcomes at least the above-mentioned issues by providing an improved volumetric mixer.

### SUMMARY

According to the present invention there is provided an apparatus and method as set forth in the appended claims. Other features of the invention will be apparent from the dependent claims, and the description which follows.

According to a first aspect of the invention, there is provided a volumetric mixer comprising a holding section adapted to store one or more materials simultaneously, one or more conveyors disposed in the holding section, a mixing section, one or more heating units disposed in the mixing section, and a control unit. The conveyors are operable to convey materials from the holding section to the mixing section. The one or more conveyors are operable to be individually controlled by the control unit to deliver a pre-determined amount of each material from the holding section to the mixing section.

The volumetric mixer may further comprise a weighing device that is operable to measure the weight of each material delivered to the mixing section, and provide feedback on the measured weight to the control unit.

The volumetric mixer may further comprise a central unit with mixing arms, operable to mix the delivered materials.

The mixing arms may contact a base of the mixing section. The part of the mixing arms contacting the base of the mixing section may be set at an angle between parallel and perpendicular to the mixing section base. The angle is such that materials are scraped from the mixing section base, to ensure the materials are sufficiently mixed.

The central unit may be controllable by a gearbox at a base of the mixing section.

The mixing section may further comprise a supply aperture, operable to deliver the mixed materials to a desired area.

The one or more heating units may be positioned so that longitudinal axes thereof form an angle with a longitudinal axis of the mixing section. Preferably, the heating units may be angled at between 30 and 60 degrees to a longitudinal axis of the mixing section. More preferably, the heating units may be angled at between 40 and 50 degrees to a longitudinal axis of the mixing section. Most preferably, the heating units may be angled at 45 degrees to a longitudinal axis of the mixing section.

One, raised, end of the holding section may be raised relative to an other, lower, end thereof. The conveyors are operable to convey the materials from the lower end to the raised end. This advantageously allows for a lower centre of gravity of the volumetric mixer.

The holding section may be adapted to receive the materials via a loading area, preferably located at a front end of the holding section.

The one or more of conveyors may extend from an end of the material holding section and into the mixing section, to deliver the raw materials into the mixing section

The control unit may be operable to receive a user input, through a user interface, specifying a desired mixture of materials and a total volume of resulting mixture.

The control unit may comprise levers to allow for manual control of the conveyors.

The control unit may control each conveyor motor to be on or off. The control unit may further control each conveyor motor, when on, to move at discrete speeds, in particular, a faster or a slower speed. Advantageously, this may allow for larger volumes of material to be loaded into the mixing section quicker.

The control unit may be operable to store several pre-set mixtures, programmed by a user.

The volumetric mixer may further comprise a secondary material holding section dispensing tank situated above the mixing section, operable to deliver a further material to the mixing section. The further material may be bitumen.

The top section of the holding section may be open on a top section, such that the holding section may receive materials.

The holding section may have a partition extending between a front wall and a rear wall. The partition creates two holding volumes for holding materials. The holding volumes are such that the materials may be stored separately, without risk of cross-contamination.

One of the ends of the conveyors may be covered by shrouds. The shrouds advantageously ensure that all of the materials being delivered by the conveyors are delivered to the mixing section. The shrouds also protect the user from being exposed to the conveyors.

The volumetric mixer may be housed by a container, such that all the components of the volumetric mixer can be moved as a whole.

The volumetric mixer may be mounted on a vehicle.

According to a first example of the invention there is also provided a method of mixing comprising a control unit controlling one or more of conveyors to convey one or more materials from a holding section to a mixing section, and heating, by one or more heating units disposed in the mixing section, the one or more of materials in the mixing section.

The method may further comprise weighing, by a weighing device, each material delivered to the mixing section, and providing feedback on the measured weight to the control unit.

The method may further comprise mixing, by a central unit with mixing arms present in the mixing section, the delivered materials

The method may further comprise controlling, by a gearbox present at the base of the mixing section, the central unit to rotate.

The method may further comprise delivering, through a supply aperture, the mixed materials to a desired area.

The method may further comprise the mixer being mounted on a vehicle.

All of the features contained herein may be combined with any of the above aspects, in any combination.

Although a few preferred embodiments of the present invention have been shown and described, it will be appreciated by those skilled in the art that various changes and modifications might be made without departing from the scope of the invention, as defined in the appended claims.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows a top view of an example of a volumetric mixer;

FIG. 2 shows a top view of the volumetric mixer, with a mixing section cover attached;

FIG. 3a shows a rear view of the volumetric mixer, with rear doors in an open configuration;

FIG. 3b shows a rear view of the volumetric mixer, with rear doors in a closed configuration;

FIG. 4a shows a side view of the volumetric mixer;

FIG. 4b shows an enlarged side view of the volumetric mixer shown in FIG. 4a;

FIG. 5 shows a front view of the volumetric mixer;

FIG. 6 shows a side view of the volumetric mixer mounted on a vehicle;

FIG. 7 shows a rear perspective view of an example of the volumetric mixer mounted on a vehicle;

FIG. 8 shows a top view of an example of the volumetric mixer mounted on a vehicle;

FIG. 9 shows a rear view of an example of the volumetric mixer mounted on a vehicle; and

FIG. 10 shows an example of a method of using the volumetric mixer.

### SPECIFIC DESCRIPTION OF EMBODIMENTS

An apparatus, method and system of the present disclosure are described below.

In particular, the present disclosure is concerned with a volumetric mixer. The volumetric mixer may be a batch mixer.

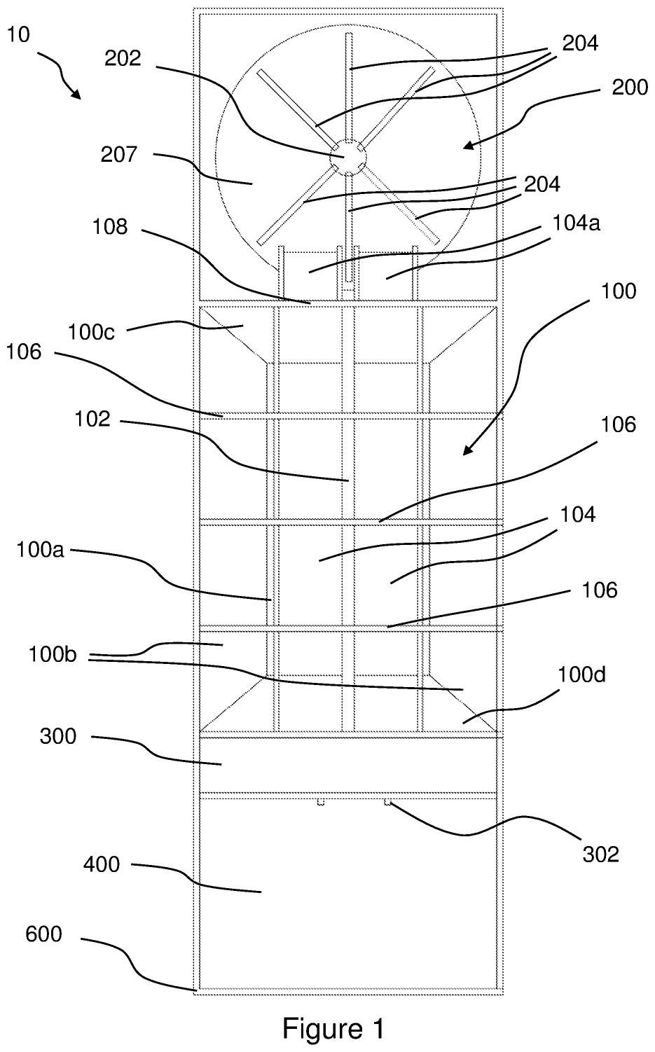

FIG. 1 shows an example of a volumetric mixer 10. The volumetric mixer 10 comprises a holding section 100. The holding section 100 is a prism with a cross section of a compound shape made up of an isosceles trapezium and a rectangle. The narrowest side of the holding section 100 is the base 100a. The holding section 100 has two side walls 100b. The holding section 100 further comprises a rear wall 100c and a front wall 100d. The top section of the holding section 100 is open, such that the holding section 100 may receive materials.

The materials may be one or more materials. The one or more materials may be tar-like materials mixed with mineral aggregates such as sand, concrete and cement. The one or more materials may be asphalt. The one or more materials may be different types of asphalt, such as 6 mm, 10 mm or 20 mm asphalt, or a combination thereof, such that the materials, when mixed, product different products. The one or more materials may be virgin or recycled.

The width of the holding section 100 is defined as the distance between the side walls 100b. The holding section 100 has the smallest width nearest the base 100a, and widest at a portion nearest the open top section of the holding section 100.

The holding section 100 has support sections 106 which extend between the side walls 100b. The support sections 106 provide additional rigidity to the holding section by bracing between the sidewalls 100b. The holding section 100 and support sections 106 may be made from reinforced steel, or other heat resistant material able to withstand and function when exposed to high temperatures.

The holding section 100 has a partition 102 extending between the front wall 100d and the rear wall 100c. The partition 102 creates two holding volumes for holding materials. The holding volumes are such that the materials may be stored separately, without risk of cross-contamination.

The holding section 100 has one or more conveyors 104 present in the holding section base 100a. The conveyors 104 extend from the front wall 100d to the rear wall 100c of the holding section 100. The rear wall 100c comprises an aperture 108. The aperture 108 is configured such that the conveyor ends 104a extend through the rear wall 100c. In this example, the one or more conveyors 104 comprise two conveyors 104, one situated either side of the partition 102. The conveyors 104 may be made of heat resistant material.

An advantage of a holding section 100 with multiple holding volumes for holding materials is that the materials can be stored and transported separately, allowing for mixing only when required. This also eliminates the need for manual handling on the materials on site, as the work is done by the conveyors to move the materials.

Positioned adjacent the holding section rear wall 100c is a mixing section 200. The mixing section 200 has a cylindrical shape, with two disc-shaped faces and a body, wherein an axis between the two disc-shaped faces of the cylinder is perpendicular to a nominal horizontal, such as the ground. The two disc-shaped faces are lower 207 and upper 206 faces, or a base 207 and a cover 206, respectively. The mixing section 200 may be made from reinforced steel, other heat resistant material.

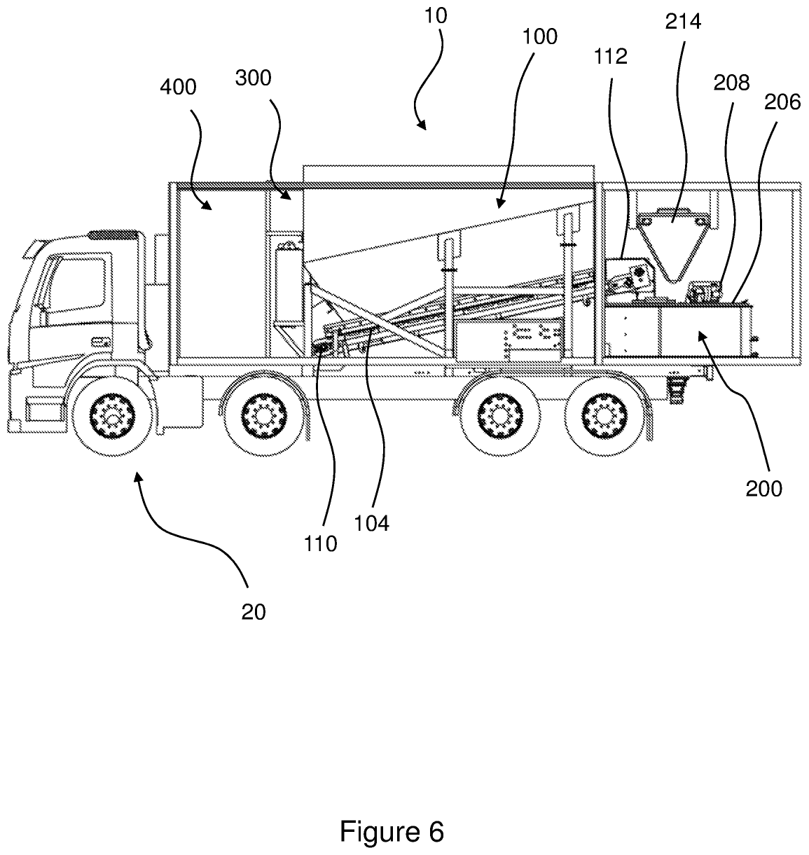

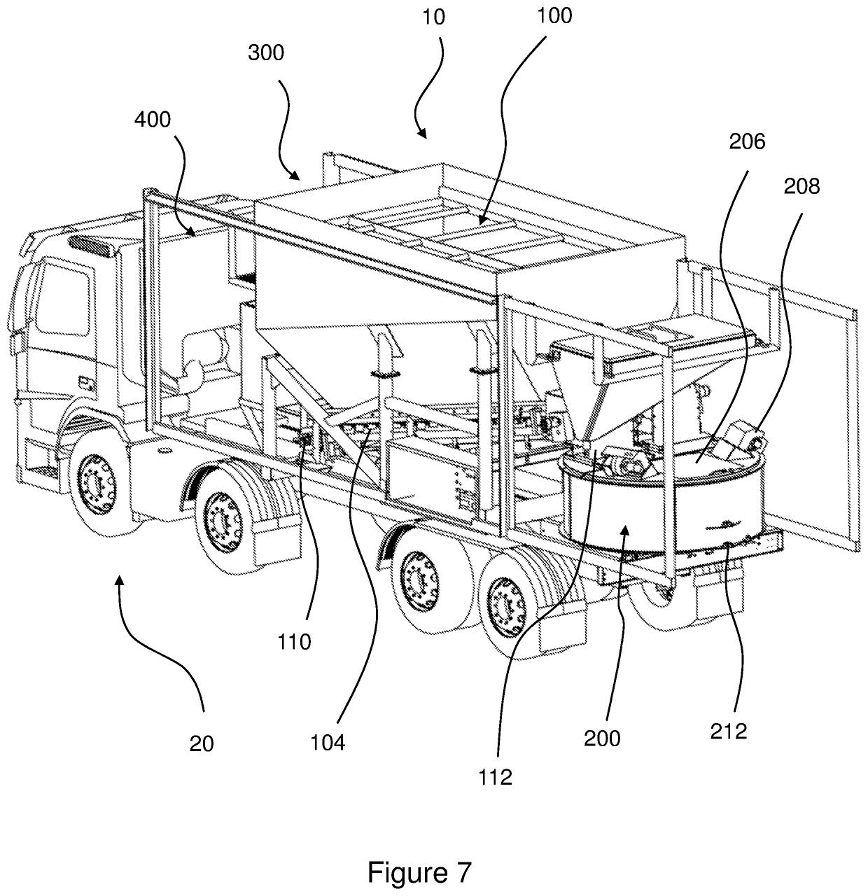

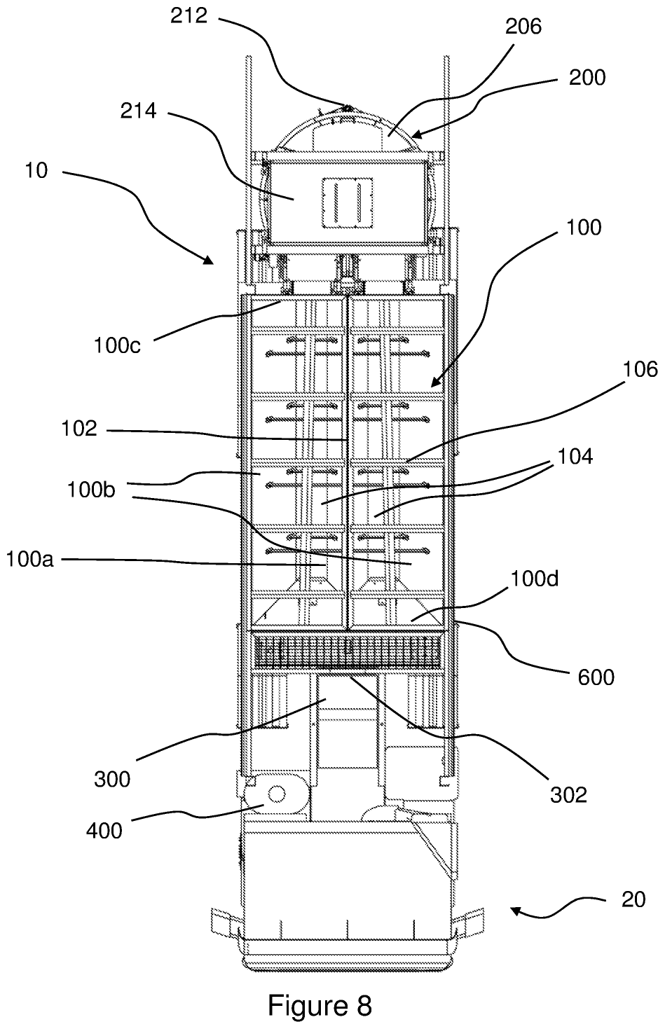

The mixing section 200 has a conveyor aperture at an upper location on the body, in a location adjacent to the holding section 100 and with a location that corresponds to the aperture 108 in the holding section rear wall 100c. This conveyor aperture allows the conveyor ends 104a to project into the mixing section 200. The conveyor aperture may be formed in the cover 206 of the mixing section 200, such that the conveyor ends 104a project above the conveyor aperture, and allows materials to be gravity fed into the mixing section 200, through the cover 206, when the materials reach the end of the conveyors 104. The conveyor ends 104a may be covered by shrouds 112 (see FIGS. 6-9). The shrouds 112 ensure that all of the materials being delivered by the conveyors 104 are delivered to the mixing section 200. The shrouds 112 further protect the user from being exposed to the conveyors 104.

Inside the mixing section 200 is a central unit 202. The central unit 202 extends from the inside of the base 207 of the mixing section 200 towards the top of the mixing section 200. The central unit 202 extends a distance such that it does not overlap or interfere with the conveyor ends 104a, so that it extends to a point below the conveyor ends 104a. The central unit 202 is mounted for rotation and is powered by a mixing section motor situated at the base of the mixing section 200. The mixing section motor rotates the central unit 202.

Extending outwardly from the central unit 202 are a plurality of mixing arms 204. The mixing arms 204 contact the base 207 of the mixing section 200. The mixing arms 204 are shaped to provide maximum distribution of the materials within the mixing section 200. For example, the mixing arms 204 may be widest towards the base of the mixing section 200, and become narrower further away from the base of the mixing section 200. The mixing arms 204 may also extend radially further from the central unit 202 at the end closest to the base of the mixing section 200 compared to the end closest to the top of the mixing section 200. The mixing arms 204 may be spiral blades extending from the central unit 202. The mixing arms 204 may be twisted, such that they each extend partly around the central unit 202. The mixing arms 204 may be rotatable paddles. The mixing arms 204 may be positioned at different angles, with respect to each other.

The mixing arms 204 may project perpendicularly from the upper most part of the central unit 202. Each of these projections may have further projections extending from a region generally away from the central unit 202 and extending in a direction parallel to the central unit 202, to the base mixing section base 207. At the end of each of these further projections, and contacting the mixing section base 207, are blades. The blades are positioned perpendicularly to the further projections, and may be set at an angle between parallel and perpendicular to the mixing section base 207. The angle is such that materials are scraped from the mixing section base 207, to ensure the materials are sufficiently mixed.

The mixing section 200 further comprises a weight cell located in the base of mixing section 200. The weight cell is operable to measure the weight of ingredients added to the mixing section 200 from the holding section 100, via the conveyors 104.

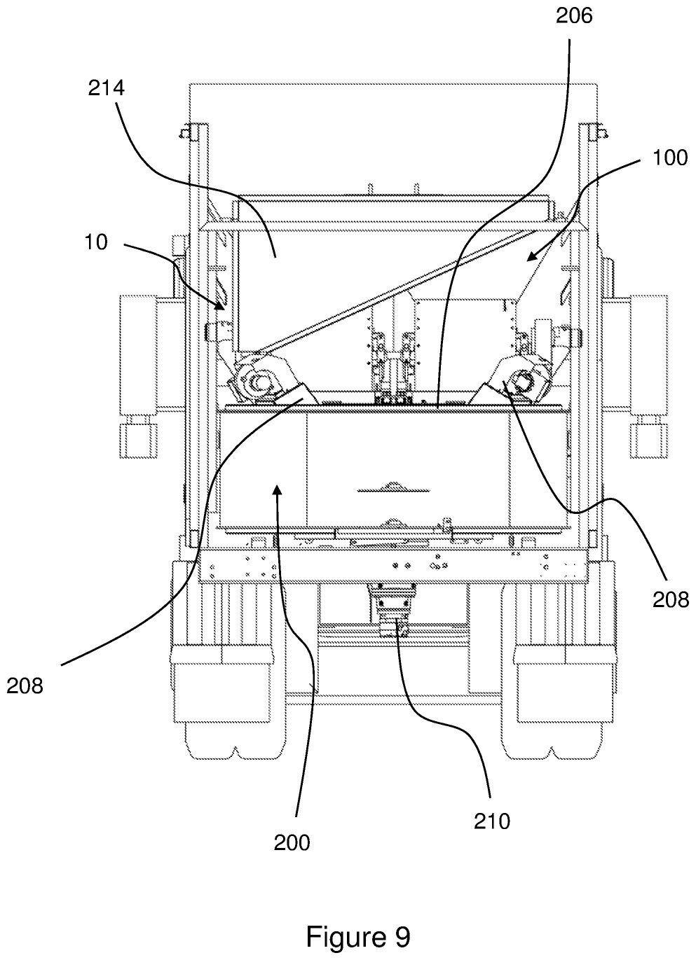

The mixing section 200 further comprises a supply aperture 210 (shown in FIG. 9) in the base 207 of the mixing section 200. The supply aperture 210 is operated by an external handle 212. The handle is operable by a user such that rotation of the handle 212 with respect to the mixing section 200 allows for moving the supply aperture 210 between and open and closed configurations. The supply aperture 210 allows mixed materials to be released from the mixing section 200.

The volumetric mixer 10 also comprises a loading area 300 at a front end thereof. The loading area 300 is a raised area, accessible using ladders 302, that allows a user to deposit materials into the holding section 100.

The volumetric mixer 10 also comprises a storage area 400 at the front end, adjacent the loading area 300, for storage of tools, equipment, user possessions and the like.

The volumetric mixer 10 is housed by a container 600, such that all the components of the volumetric mixer 10 can be moved as a whole.

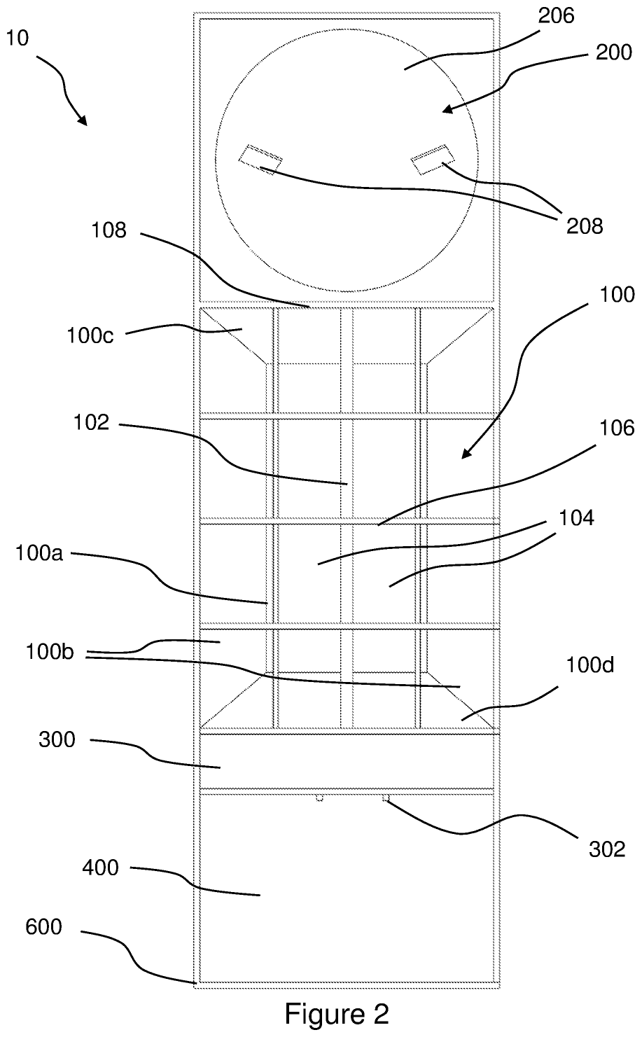

FIG. 2 shows a top view of the volumetric mixer 10, with a mixing section cover 206 in place. The mixing section cover 206 is hingedly attached to the mixing section 200, and may be opened and closed by a user.

The mixing section cover 206 has moulded raised sections, which house heating units 208. The heating units 208 are formed in the moulded raised sections of the cover 206, and therefore may be raised and lowered as the cover is opened and closed. Because the heating units 208 are integral to the cover 206, a user does not need to manually handle the heating units 208. Furthermore, heat may be more efficiently retained within the mixing section 200. Preferably, and as shown in FIG. 2, there are two heating units 208.

The heating units 208 are positioned so that longitudinal axes thereof form an angle with a longitudinal axis of the mixing section 200. Preferably, the heating units 208 are angled at approximately 45 degrees to a longitudinal axis of the mixing section 200. The heating units 208 may be oil burners. The heating units 208 may be gas burners, such as propane burners. The heating units 208 may be electric burners.

By providing the heating units 208 within the mixing section cover 206, a user does not need to handle the heating units 208. By lowering the cover 206, the heaters are also lowered, thus reducing the need for a user to touch the heating units 208.

An advantage of having discrete holding and mixing sections (100, 200) is that the materials can be stored and transported separately. The materials can then be mixed as and when is required, thereby reducing waste and keeping costs to a minimum.

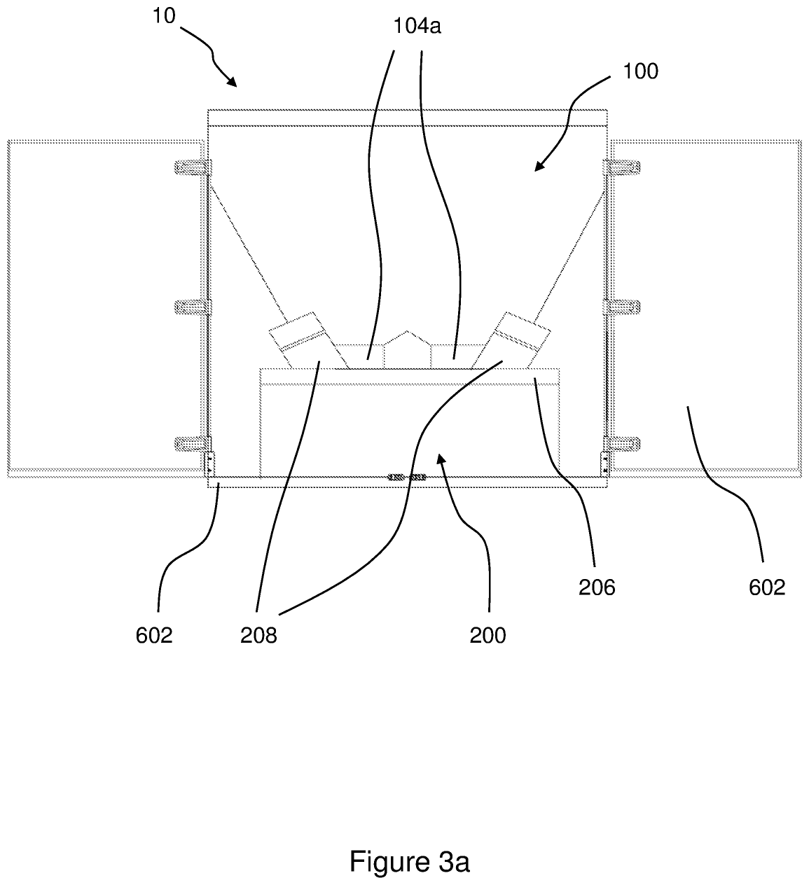

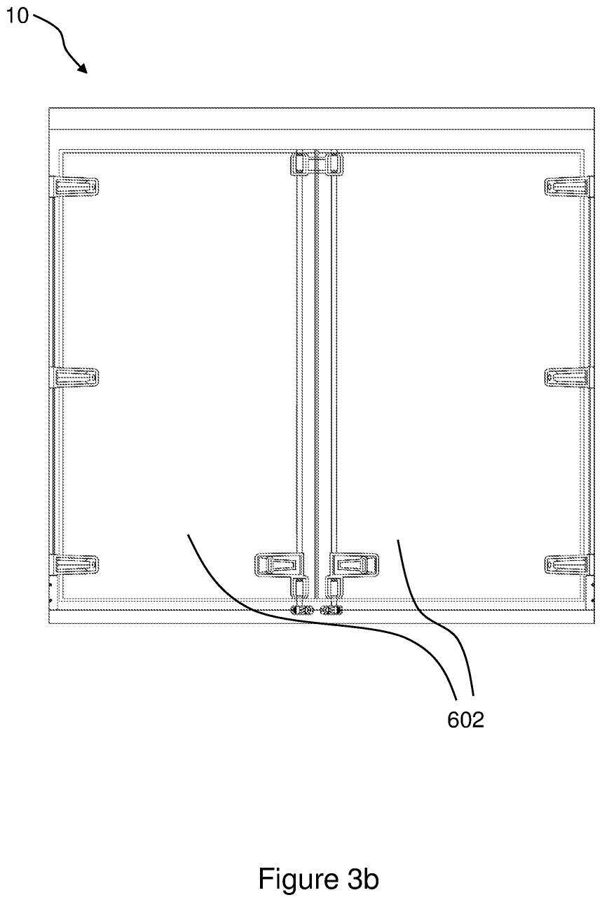

FIG. 3a shows a rear view the volumetric mixer 10, with rear doors 602 open. The rear doors 602 form part of the container 600. The rear doors 602 allow the mixing section 200 to be enclosed, as shown in FIG. 3b. The rear doors 602 may be closed, for example, during transit.

The volumetric mixer 10 may further comprise a secondary material holding section 214 (shown in FIGS. 6-9) that may separately feed the mixing section 200. The secondary material holding section 214 may be positioned above the mixing section 200, such that any material is holds may be gravity fed into the mixing section 200, when the cover 206 is in its open position. The secondary material holding section 214 may be for holding bitumen.

The cover 206 of the mixing section 200 may be split into two sections, such that there is a rear section that houses the heating units 208, and a front section that provides access to the conveyor ends 104a.

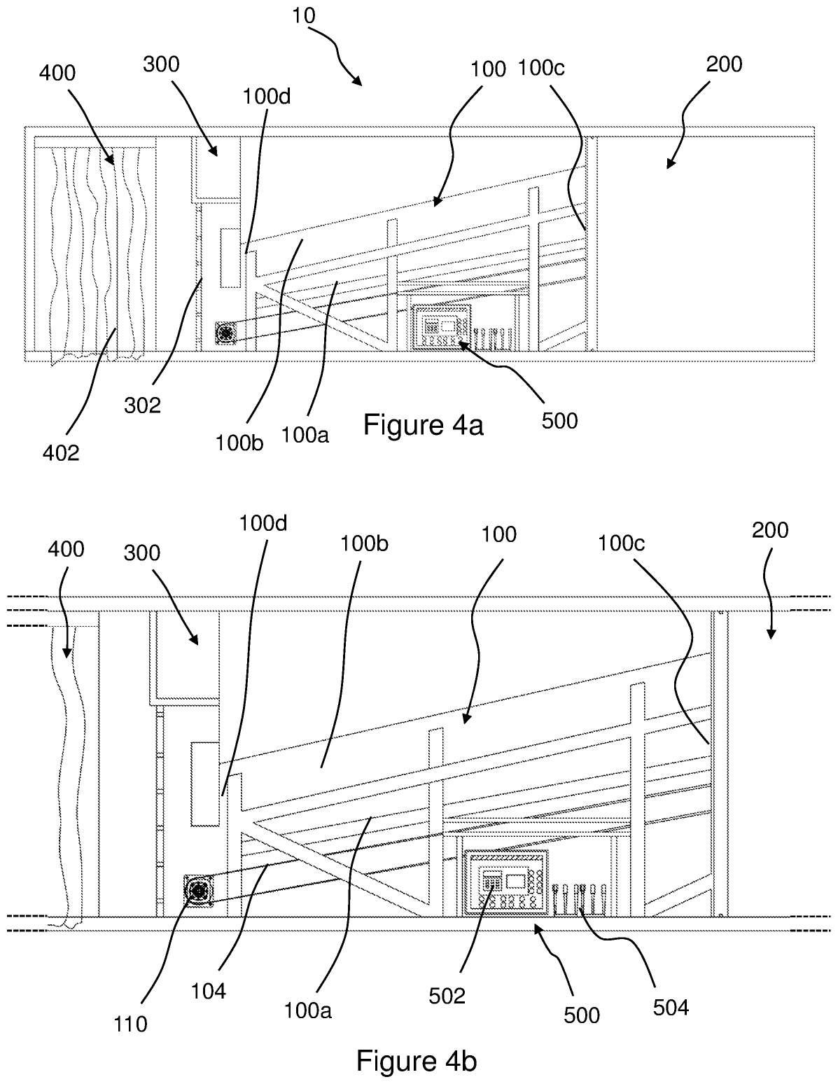

FIG. 4a shows a side view of the volumetric mixer 10. FIG. 4b shows an enlarged side view the volumetric mixer 10.

FIGS. 4a and 4b show the position of the holding section 100. The holding section base 100a holding section is raised at the rear wall 100c, such that the rear wall 100c is higher than the front wall 100d. The holding section base 100a is angled in such a way so that the conveyors 104 can efficiently feed the mixing section 200. The holding section base 100a holding section is angled such that the holding section aperture 108 aligns with the conveyor aperture. The angle of the holding section base 100a provides a further advantage of maintaining a lower centre of gravity. If the holding section base 100a was not raised at the rear end, the entire holding section 100 would have to be raised, to allow the holding section aperture 108 and the aperture of the mixing section to align. This would raise the centre of gravity of the volumetric mixer 10, meaning the volumetric mixer 10 would be less stable. The angle of the holding section base 100a allows for the accommodation of the control unit.

The volumetric mixer 10 further comprises a control unit 500. The control unit 500 controls the conveyors 104, via respective conveyor motors 110, and the central unit motor. The control unit 500 controls each conveyor motor 110 to be on or off. The control unit 500 may control each conveyor motor 110, when on, to move at discrete speeds, in particular, a faster or a slower speed. The control unit 500 controls the conveyor motor 110 to move the conveyors 104 such that materials are moved from the front to the rear of the holding section 100, thereby delivering materials to the mixing section 200. The shape of the holding section ensures that all of the materials move downward towards the conveyors.

The control unit 500 may further control the heating unit 208. The control unit 500 receives weight information from the weight cell.

The control unit 500 comprises a user interface 502 and levers 504.

The control unit 500 may be programmed by a user, to store several pre-set mixtures. The user may programme several mixture compositions. The control unit 500 is then able to calculate the volume or weight of each material required to give a total volume or weight input by a user.

The control unit 500 controls each conveyor motor 110 to move each conveyor 104, in turn, to deliver a desired amount of each material to the mixing section 200. The control unit 500 receives feedback from the weight cell, such that the control unit 500 can stop each conveyor 104 when the desired weight of each material has been delivered into the mixing section 200.

By having a control unit 500 that can store composition information, and deliver a total weight of such composition, based on a user input, the amount of waste material is reduced.

The levers 504 enable a user to manually control each of the conveyors, as well as the mixing section motor.

FIGS. 4a and 4b also show the storage area 400 and storage cover 402. The storage cover 402 ensures that items in the storage area are enclosed and protected.

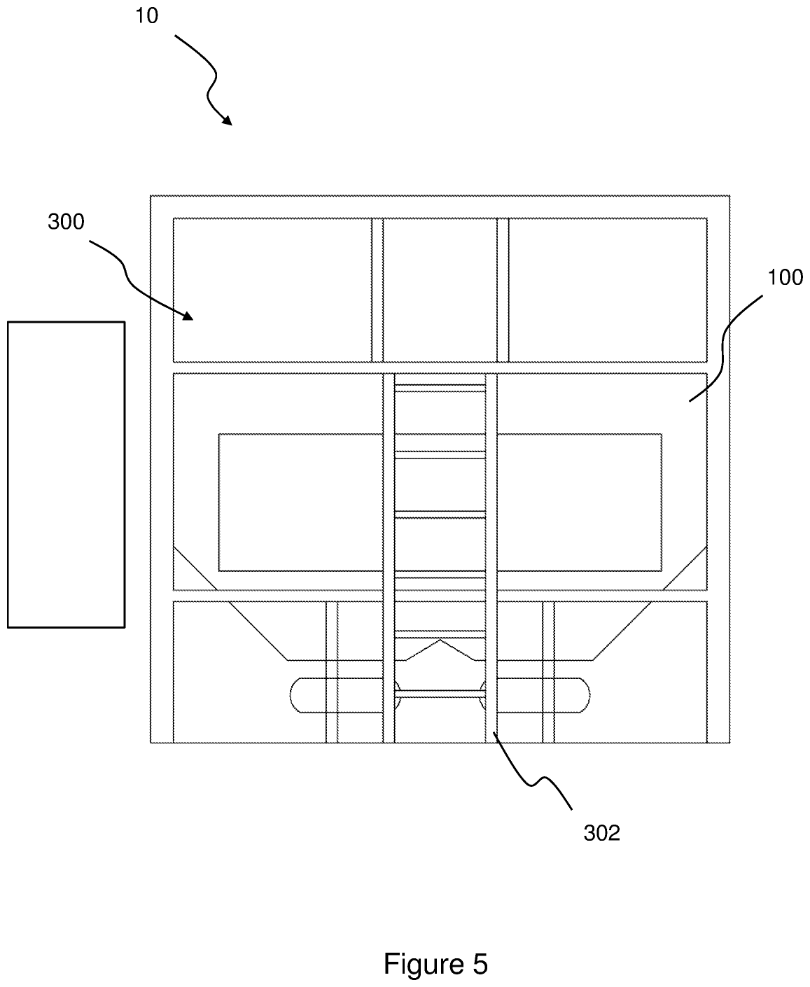

FIG. 5 shows a view of the volumetric mixer 10. The ladder 302 give a user access to the loading area 300, to load materials into the holding section 100.

The volumetric mixer 10 may be mounted on a vehicle 20, as shown in FIGS. 6-9. By having the volumetric mixer 10 mounted on a vehicle 20, the volumetric mixer 10 may be easily transported. In particular, the volumetric mixer may be loaded with materials off site, transported to a desired location, and the materials mixed and heated once at location where they are to be used. Additionally, the volumetric mixer 10 may be delivered to a location to use and remain in a delivered location off the vehicle 20 until it has been used and needs to be removed for re-filling.

In use, a user accesses the holding section 100 using the ladder 302 and loading area 300. The user loads materials, such as asphalt, into the holding section 100. The user may load different types of material into each holding area. For example, the user may load 20 mm asphalt into one holding area, and 6 mm asphalt into the other. Different sizes of asphalt mix together in different ratios to give different types of tarmac, for example, a ‘topping’ and a ‘base’. Because the loading area is elevated above the holding section 100, the loading area 300 allows a user to safely load materials into the holding section 100.

The user may have previously created pre-determined mixture compositions, and input them into the control unit 500, via the user interface 502. For example, the user may programme a ‘topping’ mixture, and a ‘base’ mixture—each of which require different ratios of differently sized asphalt.

Once the desired materials are loaded into the holding section 100, the volumetric mixer 10, if mounted on a vehicle 20, may be driven to a desired site location. The user ensures that the rear doors 602 are closed during transit. None of the materials need to be mixed before, or during, transit of the volumetric mixer 10; therefore, energy is conserved, and no materials are wasted.

When the volumetric mixer 10 is in the desired location, a user may use the user interface 502 of the control unit 500 to select the desired pre-programmed mixture (e.g. ‘base’) and also input the desired total weight or volume of tarmac to be made.

The control unit 500 then controls the conveyor motor 110 of a first conveyor 104 to move the first conveyor 104 to deposit a first material from one of the holding volumes of the holding section 100 into the mixing section 200. The weight cell provides feedback to the control unit 500. If the amount of material is large, the control unit 500 may increase a speed at which the conveyor motor 110 is moving, to increase the rate of flow of the material. When the desired weight of the first material has been deposited into the mixing section 200, the control unit 500 will stop the conveyor motor 110 of the first conveyor 104, thereby stopping the first conveyor 104.

The control unit 500 then repeats this process with the conveyor motor 110 of a second conveyor 104, to deposit the desired weight of a second material into the mixing section 200.

The user then uses the user interface 502 of the control unit 500 to initiate rotation of the central unit 202 of the mixing section 200. The rotation of the central unit 202 causes the mixing arms 204 to rotate and mix the mixture.

The user will also use the user interface 502 of the control unit 500 to turn on the heating units 208. The materials are then mixed and heated for a desired amount of time.

The control of the first and second conveyors may be effected at the same time to introduce the two materials for mixing concurrently.

Once the materials are mixed to form tarmac, the user may open the rear doors 602, and open the supply aperture 210 using a handle. The mixed tarmac will move through the supply aperture 210, the movement caused by gravity. The user may have either positioned the volumetric mixer 10 over the tarmac's final location, or have positioned an intermediate transporting device, such as a wheelbarrow, to deliver the tarmac to a further location.

An advantage of the volumetric mixer is that the materials can be mixed on site. By mixing on site, tarmac can be produced when needed, rather than pre-produced in large batches. This on-demand mixing reduces the amount of waste product produces, thereby saving costs for a client, because the client only pays for what they actually use. On-demand mixing also reduces waste product produced.

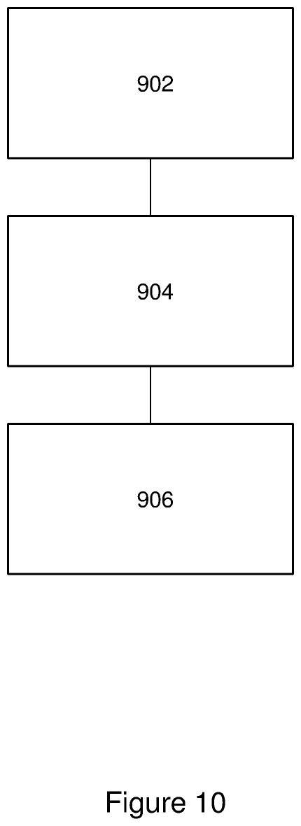

FIG. 10 shows an example of a method of using the volumetric mixer 10. The method comprising a first step 902 of a control unit controlling one or more conveyors to convey one or more materials from a holding section to the mixing section. The method further comprises a second step 904 of heating, by the one or more heating units disposed in the mixing section, the one or more materials in the mixing section. The supply aperture 210 is then opened at step 906 and the mixed tarmac is dispensed from the volumetric mixer 10.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-19. (canceled)

20. A volumetric mixer comprising:
a holding section adapted to store one or more materials simultaneously,
one or more conveyors disposed in the holding section,
a mixing section,
one or more heating units disposed in the mixing section, and
a control unit;
wherein the conveyors are operable to convey materials from the holding section to the mixing section,
wherein the one or more conveyors are operable to be individually controlled by the control unit to deliver a pre-determined amount of each material from the holding section to the mixing section.

21. The volumetric mixer of claim 20, wherein the mixing section comprises a weighing device that is operable to measure the weight of each of the materials delivered to the mixing section and provide feedback on the measured weight to the control unit.

22. The volumetric mixer of claim 20, wherein the mixing section further comprises a central unit with mixing arms, operable to mix the delivered materials.

23. The volumetric mixer of claim 22, wherein the central unit is controllable by a gearbox at a base of the mixing section.

24. The volumetric mixer of claim 20, wherein the mixing section further comprises a supply aperture, operable to deliver the mixed materials to a desired area.

25. The volumetric mixer of claim 20, wherein one, raised, end of the holding section is raised relative to an other, lower, end thereof.

26. The volumetric mixer of claim 25, wherein the conveyors are operable to convey the materials from the lower end to the raised end.

27. The volumetric mixer of claim 20, wherein the holding section is adapted to receive the materials via a loading area, preferably located at a front end of the holding section.

28. The volumetric mixer of claim 20, wherein the one or more conveyors extend from an end of the holding section and into the mixing section, to deliver the raw materials into the mixing section.

29. The volumetric mixer of claim 20, wherein the control unit is operable to receive a user input, through a user interface, specifying a desired mixture of materials and a total volume of resulting mixture.

30. The volumetric mixer of claim 20, wherein the control unit comprises levers to allow for manual control of the conveyors.

31. The volumetric mixer of claim 20, further comprising a secondary material holding section dispensing tank situated above the mixing section, operable to deliver a further material to the mixing section.

32. The volumetric mixer of claim 20, wherein the volumetric mixer is mounted on a vehicle.

33. A method of mixing comprising:
controlling, by a control unit, one or more of conveyors, disposed in a holding section, to convey one or more materials from the holding section to a mixing section, and
heating, by one or more heating units disposed in the mixing section, the one or more materials in the mixing section.

34. The method of claim 33, further comprising weighing, by a weighing device, each material delivered to the mixing section, and providing feedback on the measured weight to the control unit.

35. The method of claim 33 further comprising mixing, by a central unit with mixing arms present in the mixing section, the delivered materials.

36. The method of claim 33 further comprising controlling, by a gearbox present at the base of the mixing section, the central unit to rotate.

37. The method of claim 33 further comprising delivering, through a supply aperture, the mixed materials to a desired area.

38. The method of claim 33 wherein the mixer mounted on a vehicle.
